(19) United States
(12) Patent Application Publication
(10) Pub. No.: US 2021/0299487 A1
(43) Pub. Date: Sep. 30, 2021

(54) DO IT YOURSELF (DIY) RESPIRATION AND VENTILATION SYSTEMS AND METHODS

(71) Applicants: Mark English, Falls Church, VA (US); Carlos R. Villamar, Falls Church, VA (US); Paul Smith, Norridgewock, ME (US)

(72) Inventors: Mark English, Falls Church, VA (US); Carlos R. Villamar, Falls Church, VA (US); Paul Smith, Norridgewock, ME (US)

(21) Appl. No.: 17/216,336

(22) Filed: Mar. 29, 2021

Related U.S. Application Data
(60) Provisional application No. 63/001,444, filed on Mar. 29, 2020.
(60) Provisional application No. 63/002,348, filed on Mar. 30, 2020.

(51) Int. Cl. A62B 18/02; A62B 7/10

(52) U.S. Cl. CPC A62B 18/02; A62B 18/006; A62B 7/10

(57) ABSTRACT

A system, method and computer program product for a do-it-yourself (DIY) system for assisted respirators, including a full-face snorkel mask with snorkel connection; a hose having a first end connected to the snorkel connection of the mask; a blower connected a second end of the hose; and a portable power supply powering the blower. The blower includes a HEPA level filter on an air input thereof, and the blower pumps HEPA filtered air through the hose into the mask.

### CROSS REFERENCE TO RELATED DOCUMENTS

The present invention is claims priority to U.S. Provisional Patent Application Ser. No. 63/001,444 of ENGLISH et al., entitled “DO IT YOURSELF (DIY) RESPIRATION AND VENTILATION SYSTEMS AND METHODS,” filed on 29 Mar. 2020, now pending, and U.S. Provisional Patent Application Ser. No. 63/002,348 of ENGLISH et al., entitled “DO IT YOURSELF (DIY) RESPIRATION AND VENTILATION SYSTEMS AND METHODS,” filed on 30 Mar. 2020, now pending, the entire disclosures of all of which are hereby incorporated by reference herein.

### BACKGROUND OF THE INVENTION

### Field of the Invention

The present invention generally relates to respiration and ventilation systems and methods, and more particularly to do respiration and ventilation systems and methods, and the like, for do it yourself (DIY) applications, and the like.

### Discussion of the Background

In recent years, respiration and ventilation systems and methods have been developed. However, such systems and methods are very costly, and lack efficiency for do it yourself (DIY) applications, and the like.

### SUMMARY OF THE INVENTION

Therefore, there is a need for methods and systems that address the above, and other problems. The above and other problems are addressed by the illustrative embodiments of the present invention, which provide respiration and ventilation systems and methods, and the like, for do it yourself (DIY) applications, and the like.

Accordingly, in illustrative aspects of the present invention there is provided a system, method and computer program product for a do-it-yourself (DIY) system for assisted respirators, including a full-face snorkel mask with snorkel connection; a hose having a first end connected to the snorkel connection of the mask; a blower connected a second end of the hose; and a portable power supply powering the blower. The blower includes a HEPA level filter on an air input thereof, and the blower pumps HEPA filtered air through the hose into the mask.

The hose is filled with a filter material.

The first and second ends of the hose include a filter material.

The system, method and computer program product further include a PEEP valve and diverter connected to the hose.

The system, method and computer program product further include a backpack for housing the blower and the portable power supply.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a diagram for illustrating a do it yourself (DIY), assisted and unassisted, respiration systems and methods, and the like;

FIG. 2 is a diagram for a DIY respiration system and method employing off the shelf full face scuba masks, and USB powered air pumps, and blowers, and the like, and that can be employed with the systems and methods of FIGS. 1 and 3-7;

FIG. 3 is a diagram for a DIY unassisted, respiration system and method employing an off the shelf full face scuba mask, and funnel shaped filter elements, and the like, and that can be employed with the systems and methods of FIGS. 1-2 and 4-7;

FIG. 4 is a diagram for a DIY unassisted, respiration system and method employing an off the shelf full face scuba mask, and cylinder-shaped filter elements, and the like, and that can be employed with the systems and methods of FIGS. 1-3 and 5-7;

FIG. 5 is a diagram for a DIY assisted respiration system and method employing voltage controllers, software applications, WiFi switches, UV lights, and the like, and that can be employed with the systems and methods of FIGS. 1-4 and 6-7;

FIG. 6 is a diagram for a DIY assisted respiration and/or ventilation system and method employing microcontrollers, software applications, sensors, air switches, O2 supplies, medical valves, power line control systems, humidification devices, and the like, and that can be employed with the systems and methods of FIGS. 1-5 and 7;

FIG. 7 is a diagram for a DIY assisted respiration and/or ventilation system and method employing microcontrollers, software applications, sensors, air switches, O2 supplies, medical valves, power line control systems, humidification devices, bidirectional blowers, and the like, and that can be employed with the systems and methods of FIGS. 1-6; and

FIG. 8 is a diagram for a backpack version of the DIY respiration system and method employing off the shelf full face scuba masks, and USB powered air pumps, and blowers, and the like, and that can be employed with the systems and methods of FIGS. 1-7;

### DETAILED DESCRIPTION OF THE PREFERRED EMBODIMENTS

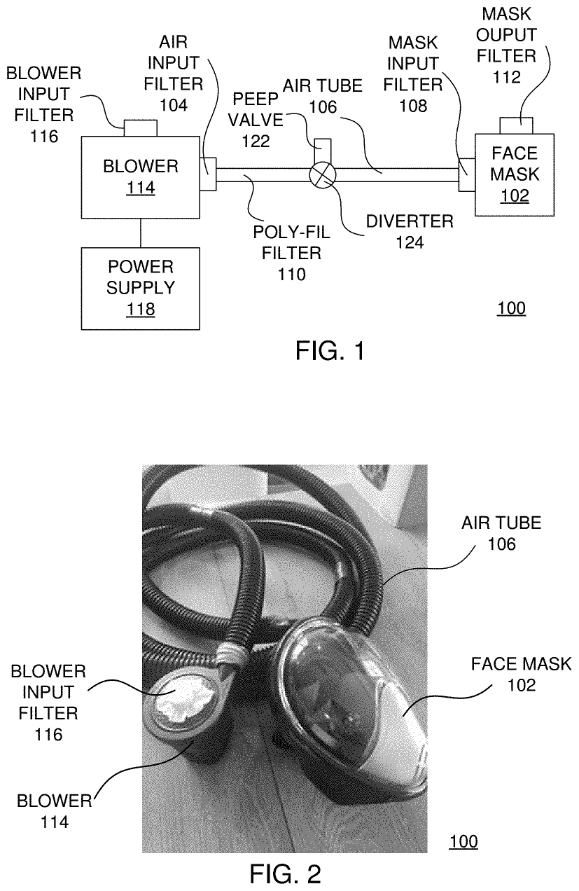

Referring now to the drawings, wherein like reference numerals designate identical or corresponding parts throughout the several views, and more particularly to FIG. 1 thereof, there is shown a diagram for illustrating a do it yourself (DIY), assisted and unassisted, respiration systems and methods, and the like. In FIG. 1, the DIY), assisted and unassisted, respiration systems and methods 100 can include a face mask 102, an air blower device 114, and power supply 118 (e.g., AC plug, batteries, AC or DC wall adaptor or convertor, USB adapter, etc.), and the like. The face mask 102 can include mask input filter 108 and output filter 112, and the like. A power supply 118 can be coupled to the blower 114 (e.g., a WM7040 DC 12V/24V High Pressure Blower 7.5 Kpa Brushless DC Blower Small Centrifugal Fan For sleep Ventilator Oxygen Treatment—12V Driver; VIVOSUN 332 GPH Air Pump 14 W 4 Outlet 21 L/min for Aquarium and Hydroponic Systems; Dr.meter Rechargeable Air Pump, HT-420 Portable Electric Air Pump, etc.) to provide AC and/or DC power, and the like. The blower 114 can include a blower input filter 116 for filtering incoming air, and the like, and optionally an air input filter 104 on the output blower 114 to provide further filtering, as needed (e.g., N95, minimum efficiency reporting value (MERV) 14-17, high-efficiency particulate air (HEPA), etc.). An air tube 106 connects the blower 114 to the face mask 102, and to provide filtered air to a user of the face mask 102. The air tube 106 can be filled with additional filtering material 110 (e.g., poly-fil material, etc.) to provide further filtering, as needed. A positive end-expiratory pressure (PEEP) valve 122, and a PEEP valve diverter 124, and the like, can be provided on the air tube 106, as needed.

FIG. 2 is a diagram for a DIY respiration system and method employing off the shelf full face scuba masks, and USB powered air pumps, and blowers, and the like, and that can be employed with the systems and methods of FIGS. 1 and 3-7. In FIG. 2, the DIY respiration system and method 100 can include mask 102 (e.g., off the shelf full face scuba mask, a full face continuous positive airway pressure (CPAP) mask, etc.) coupled to the blower 114 (e.g., a USB powered air pump, aquarium air pump, etc.), and the like, via an air tube 106 (e.g., a sump pump hose, washing machine hose, pool pump hose, etc.). The blower 114 includes the blower input filter 116, and the like, as previously described.

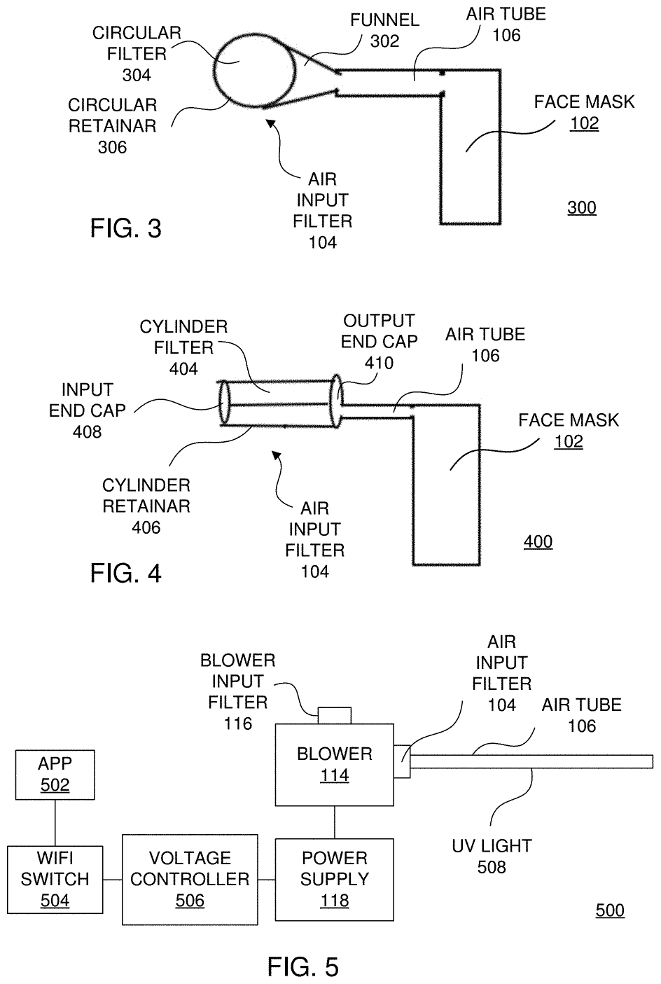

FIG. 3 is a diagram for a DIY unassisted, respiration system and method employing an off the shelf full face scuba mask, and funnel shaped filter elements, and the like, and that can be employed with the systems and methods of FIGS. 1-2 and 4-7. In FIG. 3, a DIY unassisted, respiration system and method 300 can include the air input filter 104 configured as a funnel 302 (e.g., an off-the-shelf funnel, etc.) that can be removably attached to the air tube 106 that is removably coupled (e.g., screw on, force fit, clamp, tape, etc.) to the mask 102. The funnel 302 of the air input filter 104 can include a circular filter element 304 (e.g., e.g., N95, MERV 14-17, HEPA, etc.) removably attached (e.g., screw on, snap on, force fit, clamp, tape, etc.) to the funnel 302 with a circular retainer 306 (e.g., rubber band, a plastic lid with holes, etc.).

FIG. 4 is a diagram for a DIY unassisted, respiration system and method employing an off the shelf full face scuba mask, and cylinder-shaped filter elements, and the like, and that can be employed with the systems and methods of FIGS. 1-3 and 5-7. In FIG. 4, a DIY unassisted, respiration system and method 400 operates in a similar manner as the method and system of FIG. 3, wherein the air filter input 104 is configured as a cylinder filter 104 (e.g., e.g., N95, MERV 14-17, HEPA, etc.) provided over (e.g., slipped over, etc.) an internal support structure (not shown, e.g., plastic cylinder with holes or slits, etc.) for supporting the cylinder filter 104. A cylinder retainer 406 can be employed to secure the cylinder filter 104 over the internal support structure (not shown). An input end cap 408 and an output end cap 410 (e.g., plastic circular screw on, snap on, force fit, clamped, taped, caps, etc.) can be removable provided to seal the cylinder filter 104 for proper filtration, and the like. The output end cap 410 can be removably coupled to the air tube 106 (e.g., plastic circular screw on, snap on, force fit, clamped, taped, caps, etc.).

FIG. 5 is a diagram for a DIY assisted respiration system and method employing voltage controllers, software applications, WiFi switches, UV lights, and the like, and that can be employed with the systems and methods of FIGS. 1-4 and 6-7. In FIG. 5, a DIY assisted respiration system and method 500 operates in a similar manner as the method and system of FIG. 1, wherein a software application 502 (e.g., a PC application, phone application, etc.) can wirelessly control a switch 504 (e.g., a WiFi enable switch, Sonoff Wifi Switch, DC5V 12V 24V 32V Wireless Relay Module Smart Home Automation Modules APP Remote Control Timer Switch Voice Control, etc.) coupled to a voltage controller 506 (e.g., and AC or DC voltage controller, etc.) that adjustably powers the power supply 118 for providing speed adjustment for the blower 114 to accommodate various filter densities, and the like. The air tube 106 can include an ultraviolet (UV), germicidal light 508 (e.g., 254 nm light UV light; rOXIN 7 W 11 W 13 W Submersible Algae Bloom Clean Light for Aquarium Water Clean Green Algae Clear Waterproof Clean Lamp for Pond Fish Tank Sump Swim Pool, etc.), and the like, to kill any remaining bacteria and viruses in the air tube 106. The light 508 can also be provided before the input filter 116, as needed.

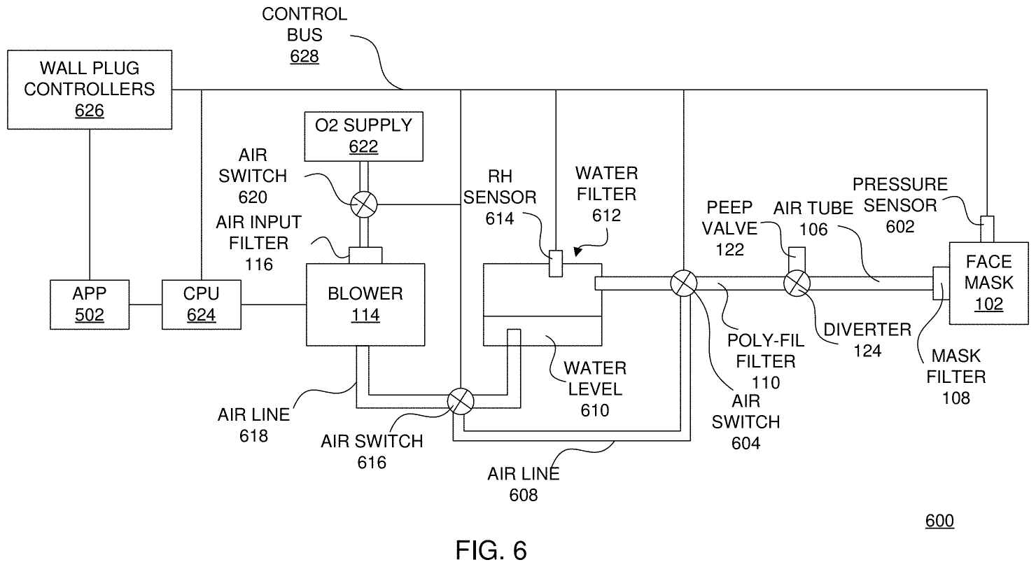

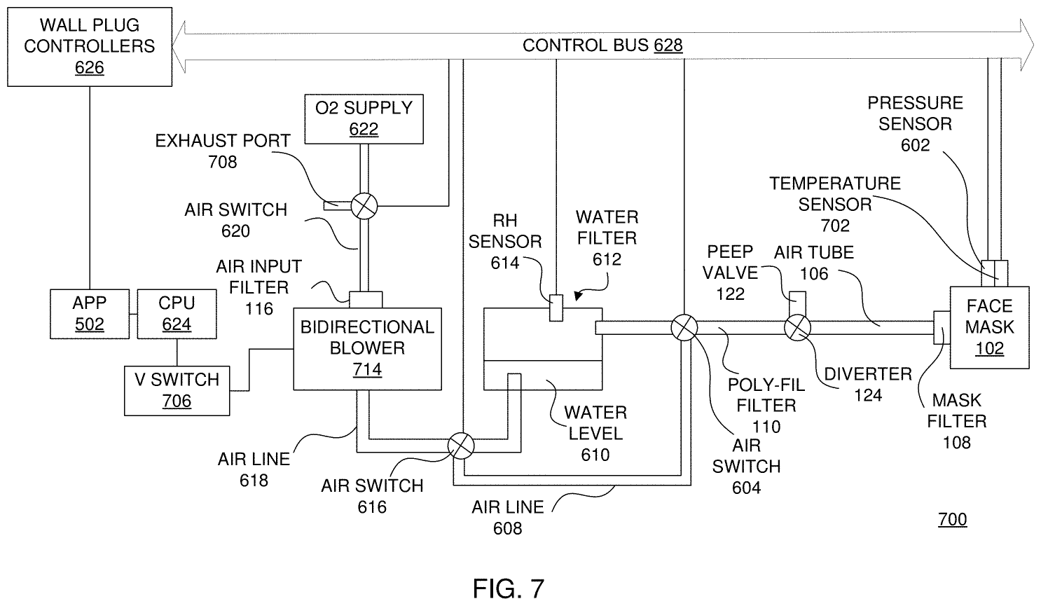

FIG. 6 is a diagram for a DIY assisted respiration and/or ventilation system and method employing microcontrollers, software applications, sensors, air switches, O2 supplies, medical valves, power line control systems, humidification devices, and the like, and that can be employed with the systems and methods of FIGS. 1-5 and 7. In FIG. 6, the DIY assisted respiration and/or ventilation system and method 600 operates in a similar manner as the method and system of FIG. 1, wherein a water filter and humidification system 612 with a predetermined water level 610, various sensors 602 and 614 (e.g., pressure, RH, temperature (as shown in FIG. 7), etc.), O2 supply 622 (as are well known, e.g., Zeolite based systems, such as described in ATACAK et al., “DESIGN AND IMPLEMENTATION OF AN OXYGEN CONCENTRATOR WITH GPRS-BASED FAULT TRANSFER SYSTEM,” Journal of Mechanics in Medicine and Biology Vol. 12, No. 4 (2012), etc.), various electronically controlled air switches 604, 616, and 620 and corresponding air lines 608 and 618, wall plug controllers 626, control bus 628, and microcontroller 624, and like. The application 502 (e.g., HomeSeer, HS3 Home Automation Software, etc.) can be used to control the CPU 624 (e.g., microcontrollers, Arduino, Raspberry Pi, etc.), wall plugs 626 (e.g., smart, home devices, etc.) and the various compatible sensors and switches (e.g., HomeSeer compatible, etc.), and the like.

FIG. 7 is a diagram for a DIY assisted respiration and/or ventilation system and method employing microcontrollers, software applications, sensors, air switches, O2 supplies, medical valves, power line control systems, humidification devices, bidirectional blowers, and the like, and that can be employed with the systems and methods of FIGS. 1-6. In FIG. 7, the DIY assisted respiration and/or ventilation system and method 600 operates in a similar manner as the method and system of FIG. 6, wherein a temperature sensor 702 can be employed to also include air temperature control for air and oxygen, and the like, entering the face mask 102. A direct current (DC) bi-directional blower 714 (e.g., bi-rotational pumps, Tesla turbines, bi-directional fan blade pumps, etc.) is provided to allow for programmable assisted respiration via the controller 624 configured for controlling a well-known programmable voltage inverter switch 706 that switches polarity of the voltage applied to a DC motor (not shown) of the blower 714 to provide for programmable assisted inhalation and exhalation through exhaust port 708, and the like.

Advantageously, the systems and methods of FIGS. 6-7 can be used provide a ventilator system that can meet minimum safe ventilator functionality based on clinical guidance, can reference hardware design for meeting minimum clinical requirements, can reference control strategies and electronics designs and supporting insights, can be used to provide results from testing in animal models, and like.

Advantageously, the systems and methods of FIGS. 6-7 can be used to satisfy clinical guidance, such as a minimum set of requirements for ventilation: Patients must be under the management of a trained clinician; the minimum controllable parameters in order to ventilate a patient include: BPM (breaths per minute): between 8-40 BPM; Tidal Volume (TV) (air volume pushed into lung): between 200-800 mL based on patient weight; I/E Ratio (inspiratory/expiration time ratio): recommended to start around 1:2; best if adjustable between range of 1:1-1:4; Assist Detection pressure. When a patient tries to inspire, they can cause a dip on the order of 1-5 cm H2O, with respect to PEEP pressure (not necessarily=atmospheric); airway pressure must be monitored; maximum pressure should be limited to 40 cm H2O at any time; Plateau pressure should be limited to max 30 cm H2O; the use of a passive mechanical blow-off valve fixed at 40 cm H2O is strongly recommended; clinician require readings of plateau pressure and PEEP (refer to clinical documentation tab); PEEP of 5-15 cm H2O required; many patients need 10-15 cmH2O; Failure conditions must permit conversion to manual clinician override, i.e. if automatic ventilation fails, the conversion to immediate ventilation must be immediate; Ventilation on room air is better than no ventilation at all. Blending of oxygen and air gas mixture to adjust FiO2 is not important in an emergency scenario. It is certainly nice to have that ability and can easily be implemented with a oxygen/air gas blender that some hospitals already have; covid-19 can get aerosolized (airborne), so HEPA filtration on the patient's exhalation is required or between the ventilator unit and the patient (at the end of the endotracheal tube) to protect clinical staff from certain infection; in-line HEPA filters can usually be purchased alongside manual resuscitator bags; heat and moisture exchanger should be used in line with the breathing circuit; failure conditions must result in an alarm, and like.

Advantageously, many of the components employed in the systems and methods of FIGS. 1-8 can be off-the-shelf components, and can be 3D printed, and the like, and employed during emergency situations, such as the 2020 covid19 worldwide pandemic, and the like, as will be appreciated by those of ordinary skill in the relevant art(s), based on the teaching of the present disclosure.

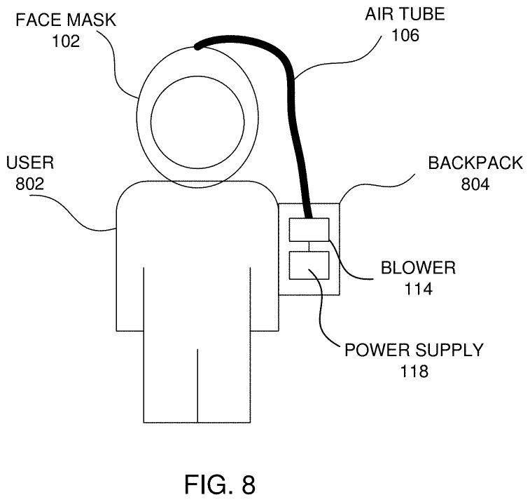

FIG. 8 is a diagram for a backpack version of the DIY respiration system and method employing off the shelf full face scuba masks, and USB powered air pumps, and blowers, and the like, and that can be employed with the systems and methods of FIGS. 1-7. In FIG. 8, a backpack 804 houses the power supply 118 (e.g., portable power supply, batteries, etc.) and blower 114 for delivering HEPA filtered air via the air tube 106 to the face mask 102 on the user 802. Advantageously, the configuration of FIG. 8 can be employed by first responders, and the like, at remote locations, and the like.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A do-it-yourself (DIY) system for assisted respirators, the system comprising:
a full-face snorkel mask with snorkel connection;
a hose having a first end connected to the snorkel connection of the mask;
a blower connected a second end of the hose; and
a portable power supply powering the blower,
wherein the blower includes a HEPA level filter on an air input thereof, and
the blower pumps HEPA filtered air through the hose into the mask.

2. The system of claim 1, wherein the hose is filled with a filter material.

3. The system of claim 1, wherein the first and second ends of the hose include a filter material.

4. The system of claim 1, further comprising:
a PEEP valve and diverter connected to the hose.

5. The system of claim 1, further comprising:
a backpack for housing the blower and the portable power supply.
